(19) United States
(12) Patent Application Publication
(10) Pub. No.: US 2026/0257933 A1
(43) Pub. Date: Sep. 3, 2026

(54) PRODUCTION OF HIGH PURITY ALUMINA AND/OR SMELTER-GRADE ALUMINA

(71) Applicant: Andromeda Technologies Holdings Pty Ltd, Adelaide (AU)

(72) Inventor: Bryn HARRIS, Ontario (CA)

(21) Appl. No.: 19/489,991

(22) PCT Filed: May 31, 2024
(86) PCT No.: PCT/AU2024/050580

§ 371 Date: Dec. 4, 2025

(30) Foreign Application Priority Data
Jun. 6, 2023 (AU) 2023901781

(51) Int. Cl. C01F 7/306; B01J 20/06; C22B 3/10; C22B 3/42; C22B 3/44; C22B 21/00; C22B 21/04

(52) U.S. Cl. CPC C01F 7/306; B01J 20/06; C22B 3/10; C22B 3/42; C22B 3/44; C22B 21/0007; C22B 21/0015; C22B 21/0038; C22B 21/04; C01P 2006/80

(57) ABSTRACT

A method for the recovery of high-grade alumina products (HPA and/or SGA) from an aluminous material feedstock, such as from kaolinite or halloysite. The process includes leaching the calcined material in recycled 18% hydrochloric acid, removal of anionic impurities such as iron and zinc via ion exchange, a novel removal step for magnesium and calcium, pyrohydrolysing the resultant solution, and washing followed by calcining of the crude alumina solids. Optionally, a final purification step is introduced via caustic leaching of the washed solids, followed by hydrolysis to gibbsite.

The present application claims priority from Australian Provisional Patent Application No. 2023901781 titled “PRODUCTION OF HIGH PURITY ALUMINA AND/OR SMELTER-GRADE ALUMINA” and filed on 6 Jun. 2023, the content of which is hereby incorporated by reference in its entirety.

### TECHNICAL FIELD

The present disclosure relates generally to processes for the recovery of alumina products, such as smelter-grade (SGA) and high-purity (HPA) from aluminous materials, particularly from halloysite and kaolinite.

### BACKGROUND

Alumina (aluminium oxide, Al₂O₃) is an intermediate product in the production of aluminium. Alumina is commonly produced from bauxite using the Bayer process which comprises high-temperature, high-pressure caustic soda leaching of the mineral bauxite to form a solution of sodium aluminate, followed by crystallisation of Gibbsite (Al(OH)₃) and calcination to form alumina, Al₂O₃, of a grade that is generally known as metallurgical alumina or SGA, smelter-grade alumina. The Bayer process remains entrenched and has seen relatively little improvement since first used, despite many attempts to find alternative methods of generating SGA. The subsequent Hall-Héroult electrolysis process demands both specific purity and physical characteristics of the alumina which is fed into the electrolytic cells, and the Bayer process, or, more correctly, the crystallisation of the sodium aluminate generated by the Bayer process, is almost uniquely positioned to deliver a product meeting these specifications.

The Bayer process requires a feed material that is generally low in silica in order to be both efficient and effective. Bauxite, an aluminium-based laterite material, which is readily-available in many locations around the world, has traditionally been the feed of choice. The notable exception to this is the use of a similar mineral, nepheline, which although somewhat more difficult to process than bauxite, has seen significant use in Russia, where there are no indigenous deposits of bauxite, but vast quantities of nepheline. Processing of nepheline requires an initial calcination step, but otherwise is very similar to the Bayer process, with the exception of a silica removal step which has to be added to the process flowsheet due to the high silica content of nepheline.

Both of the above-mentioned commercial processes employ a caustic soda leaching step, and both generate copious amounts of an iron oxide residue, the so-called red mud, which has to be disposed of and is a major environmental liability. In order to overcome the red mud issue, many attempts have been made over the years to develop an acid-based chloride leaching process, and to take advantage of the unusual properties of aluminium chloride, AlCl₃, and more specifically of aluminium chloride hexahydrate, AlCl₃·6H₂O, ACH. Despite considerable efforts made by the United States Bureau of Mines (USBM) over many years, it was extremely difficult to achieve the required purity and morphology of alumina via this technique, and the process was abandoned. The major problem elements were iron and magnesium. There were also significant health and safety issues with high levels of atmospheric HCl associated with the crystallisation and filtration unit operations.

More recent attempts at developing acid-based chloride leaching processes have involved leaching aluminous clay in recycled hydrochloric acid, and crystallising aluminium chloride from the leach solution by sparging in almost dry hydrogen chloride gas (U.S. Pat. No. 9,382,600). The resultant crystals are then calcined to recover the chloride component for recycle and to form alumina. Apart from any impurity issues, the costs of generating the dry hydrogen chloride gas in large volumes are very high.

More recently, there have been efforts focussed on making only small-volume, high-value HPA (high-purity alumina), rather than SGA, and which is targeted at the burgeoning electronic and electric vehicle industry. None has achieved significant commercial operation.

It will be evident from the foregoing that there is a need for processes that are able to produce SGA or HPA grade alumina without recourse to either the generation of red mud or the crystallisation process requiring dry hydrogen chloride gas, and from any alumina-bearing feedstock, but notably from relatively high-grade ones, such as kaolinite, halloysite or a mixture of kaolinite and halloysite. Alternatively, or in addition, there is a need for processes which are able to produce SGA or HPA grade alumina from any alumina-bearing feedstock that provide a useful alternative to known processes.

### SUMMARY

In accordance with a broad aspect of the present disclosure, a process for the recovery of alumina of at least smelter-grade purity from an alumina-bearing feedstock is described.

According to a first aspect, there is provided a process for producing alumina from an aluminous material feedstock, the process comprising:
i. producing an AlCl₃ liquor,
ii. reducing the content of impurities in the AlCl₃ liquor by ion exchange or solvent extraction to produce a semi-purified AlCl₃ liquor,
iii. pyrohydrolysing the semi-purified AlCl₃ liquor to produce crude alumina solids,
iv. washing the crude alumina solids to remove non-hydrolysable chlorides and/or residual alkaline earth oxides and bicarbonates and produce washed solids, and
v. drying and calcining the washed solids to produce alumina.

In certain embodiments of the first aspect, the process further comprises redissolution of the alumina obtained from step iv in caustic soda solution followed by hydrolysis to form gibbsite.

In certain embodiments of the first aspect, the process further comprises removing magnesium and calcium from the semi-purified AlCl₃ liquor produced in step ii. In these embodiments, magnesium and calcium can be removed from the semi-purified AlCl₃ liquor by adding a fluoride ion to effect the precipitation of magnesium and calcium. The source of the fluoride ion may be aluminium fluoride.

In certain embodiments of the first aspect, the aluminous material is a kaolinitic material. For example, the kaolinitic material may be the mineral kaolinite, halloysite or a mixture of kaolinite and halloysite. In certain other embodiments of the first aspect, the aluminous material is an aluminium containing process by-product, such as red mud.

In certain embodiments of the first aspect, step i comprises:
ia. calcining the aluminous material feedstock to produce a calcine product,
ib. leaching the calcine product in hydrochloric acid to produce a leach slurry, and
ic. removing silicate residue from the leach slurry by solid-liquid separation to produce the AlCl₃ liquor.

In certain embodiments of the first aspect, the process further comprises recovering hydrochloric acid from step iii and feeding the recovered hydrochloric acid to leaching step ib.

In certain embodiments of the first aspect, the calcination temperature used in step ia is from about 600° C. to about 1000° C., such as from about 800° C. to about 900° C., for example about 850° C.

In certain embodiments of the first aspect, the leaching temperature used in step ib is from ambient to boiling, such as from about 80° C. to about 100° C., for example from about 90° C. to about 95° C.

In certain embodiments of the first aspect, the acid strength of the hydrochloric acid used in step ib is from 5% to 35% HCl, such as about 18%.

In certain embodiments of the first aspect, step ii comprises a first stage comprising a step of reducing the amount of anionic impurities, such as, but not limited to, iron, zinc and chromium, by contacting the AlCl₃ liquor with a quaternary or tertiary amine extractant.

In certain embodiments of the first aspect, step ii. further comprises a second stage comprising a step of reducing the amount of complex cationic impurities, such as, but not limited to, titanium, by contacting the AlCl₃ liquor with a cationic exchanger. The cationic exchanger may be a phosphinic acid or an iminodiacetic acid.

In certain embodiments of the first aspect, step ii further comprises a third stage comprising a step of reducing the amount of silica by contacting the AlCl₃ liquor with an inorganic adsorbent. The inorganic adsorbent may be calcined hydrated ferric oxide.

In certain embodiments of the first aspect, step iii comprises pyrohydrolysing the AlCl₃ liquor in a spray or fluid bed roaster at a temperature below about 900° C., such as below about 800° C. In certain of these embodiments, pyrohydrolysis is carried out with a gas phase containing a partial pressure of carbon dioxide (CO₂) of no greater than 20% by volume, such as about 15% by volume. In these embodiments, the carbon dioxide reacts with the calcium and magnesium present in the semi-purified AlCl₃ liquor, converting them to their bicarbonates. The bicarbonates that are formed are highly soluble in water, and thus calcium and magnesium are easily removed in the subsequent washing step. Aluminium, on the other hand, does not form carbonates, and hence converts into its oxide.

In certain embodiments of the first aspect, step iv comprises washing crude alumina solids using de-ionised or distilled water. The washing step is designed to remove non-hydrolysable metal chlorides, in particular the alkali metal and alkaline earth metal chlorides such as, but not limited to, sodium, potassium and calcium.

Advantageously the washing step will also remove residual amounts of magnesium and calcium, which may be present as their oxides or oxychlorides, but especially as their bicarbonates as noted above. The former compounds have a small, but finite, solubility, and can be removed, but the bicarbonates are highly soluble in water, and are, therefore, much more easily removed from the alumina solids.

According to a second aspect, there is provided alumina produced by the process of the first aspect.

### BRIEF DESCRIPTION OF FIGURES

Embodiments of the present disclosure will be discussed with reference to the accompanying figures wherein:

FIG. 1 is a process flow diagram showing an embodiment of the present disclosure;

FIG. 2 is a process flow diagram showing another embodiment of the present disclosure;

FIG. 3 shows a plot of cumulative HCl release over time for the pyrohydrolysis of AlCl₃ solution at 500° C., 600° C. and 700° C.; and

FIG. 4 shows a plot of cumulative HCl release over time for the pyrohydrolysis of AlCl₃ solution at 600° C. under various CO₂ partial pressures.

In the following description, like reference characters designate like or corresponding parts throughout the figures.

### DESCRIPTION OF EMBODIMENTS

Embodiments of the present disclosure will be more clearly understood with reference to the following detailed description.

Details of terms used herein are given below for the purpose of guiding those of ordinary skill in the art in the practice of the present disclosure. The terminology in this disclosure is understood to be useful for the purpose of providing a better description of particular embodiments and should not be considered limiting.

Unless otherwise explained, all technical and scientific terms used herein have the same meaning as commonly understood by one of ordinary skill in the art to which this disclosure belongs.

In the context of the present disclosure, the terms “about” and “approximately” are used in combination with an amount, number, or value, then that combination describes the recited amount, number, or value alone as well as the amount, number, or value plus or minus 10% of that amount, number, or value. By way of example, the phrases “about 40%” and “approximately 40%” disclose both “40%” and “from 36% to 44%, inclusive”.

As used herein, % or wt. % means weight % unless otherwise indicated. When used herein % refers to weight % as compared to the total weight percent of the phase or composition that is being discussed.

The singular terms “a”, “an”, and “the” include plural referents unless context clearly indicates otherwise. The term “comprises” means “includes”. Therefore, comprising “A” or “B” refers to including A, including B, or including both A and B.

Although methods and materials similar or equivalent to those described herein can be used in the practice or testing of the present disclosure, suitable methods and materials are described herein. In case of conflict, the present specification, including explanations of terms, will control. In addition, the materials, methods, and examples are illustrative only and not intended to be limiting.

As previously discussed, prior art processes for producing alumina from bauxite and nepheline have involved the Bayer process, which is pressure caustic leaching. Prior art processes for producing alumina from kaolinite or aluminous clays have generally involved either crystallisation of ACH (aluminium chloride hexahydrate, AlCl₃·6H₂O) in one form or another or precipitation with caustic which generates a gel-like precipitate which requires the use of a centrifuge for solid/liquid separation and liquor retention is very high, leading to mass balance problems.

In contrast to known prior art processes, the present inventor has developed a process that produces alumina (either SGA of HPA) without an ACH crystallisation step or a caustic precipitation step. Thus, disclosed herein is a process for producing alumina from an aluminous material feedstock. The process comprises:
i. producing an AlCl₃ liquor,
ii. reducing the content of impurities in the AlCl₃ liquor by ion exchange or solvent extraction to produce a semi-purified AlCl₃ liquor,
iii. pyrohydrolysing the semi-purified AlCl₃ liquor to produce crude alumina solids,
iv. washing the crude alumina solids to remove non-hydrolysable chlorides and/or residual alkaline earth oxides and bicarbonates and produce washed solids, and
v. drying and calcining of the washed solids to produce alumina.

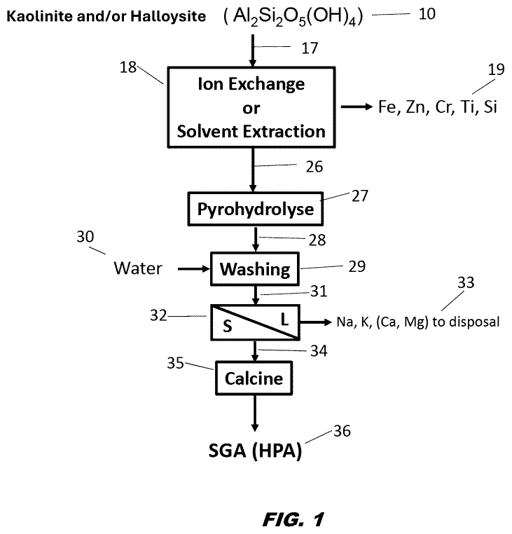

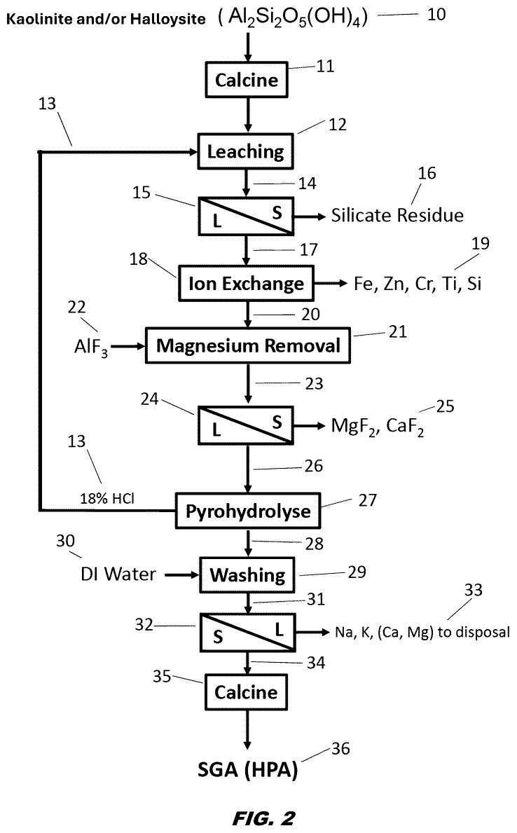

Embodiments of this process are shown in FIGS. 1 and 2. Referring to FIG. 1, there is shown a process for producing alumina 36 from an aluminous material feedstock 10. Broadly speaking, the aluminous material feedstock 10 can be any aluminium containing material having a mass fraction of aluminium oxide of 20% to 27% by weight, relative to the total material weight. The aluminous material feedstock 10 preferably has an iron content of less than about 30%. The aluminous material feedstock 10 may be an ore. Suitable ore materials include, but are not limited to, kaolinite, halloysite, and aluminium-containing ores, such as, muscovite, pyrophyllite, margarite or chlorite. An iron depleted bauxite derived material could also be used. The aluminous material feedstock 10 could also be an aluminium alkoxide, such as one produced from aluminium metal and alcohol or furnace skim, drosses or residues. The aluminous material feedstock 10 could also be an aluminium containing process by product, such as red mud. In some preferred embodiments, the aluminous material feedstock 10 is an aluminous clay or kaolinitic type material, such as halloysite (Al₂Si₂O₅(OH)₄) or kaolinite (Al₂Si₂O₅(OH)₄). The aluminous material feedstock 10 could also be a combination of any two or more of the above materials.

An AlCl₃ liquor 17 is produced from the aluminous material feedstock 10. The content of impurities 19, such as iron (Fe), zinc (Zn), chromium (Cr), titanium (Ti) and silicon (Si), in the AlCl₃ liquor 17 is reduced by ion exchange or solvent extraction to produce a semi-purified AlCl₃ liquor 26. The semi-purified AlCl₃ liquor 26 is pyrohydrolysed 27 to produce crude alumina solids 28. The crude alumina solids 28 are washed 29 with water 30 to remove non-hydrolysable chlorides and/or residual alkaline earth oxides and bicarbonates to produce a washed solids slurry 31 and, additionally, residual magnesium and calcium oxides or oxychlorides or bicarbonates. Liquid 33 containing impurities such as sodium (Na), potassium (K), calcium (Ca) and magnesium (Mg), is separated from washed solids 34 in a solid liquid separation step 32. The washed solids 34 are then dried and calcined in a calcining step 35 to produce alumina 36. Further details of each of these steps are described below.

Referring to FIG. 2, a further embodiment is shown schematically. An AlCl₃ liquor 17 is produced from aluminous material feedstock 10, in this embodiment halloysite (Al₂Si₂O₅(OH)₄) and kaolinite (Al₂Si₂O₅(OH)₄) (either 1% halloysite and 87% kaolinite or 32% halloysite and 58% kaolinite), by calcining 11 to ensure that the mineral is amenable to acid leaching 12 with recycled hydrochloric acid 13. The calcination 11 temperature may be from 600° C. to 1000° C., preferably from 800° C. to 900° C., and more preferably about 850° C. Calcining 11 may be conducted in any suitable piece of equipment, but a rotary kiln is preferred.

The calcined material is then subjected to a leaching step 12. Leaching is carried out at a temperature from ambient to boiling, but is optimally 80° C. to 100° C., more preferably about 90° C. to 95° C. The wt. % solids loading is adjusted to the strength of the acid such that maximum aluminium extraction is obtained, typically being about 95% to 98%. The strength of the hydrochloric acid may be from 5% to 35%, and will be dependent upon downstream operations. In this embodiment, spray roasting is employed such that the acid strength will be about 18% HCl. Any suitable leaching mechanism, such as, atmospheric or pressurised stirred tank reactors, may be employed.

The principal leaching reaction for the dissolution of aluminium is shown in equation (1).

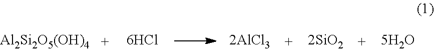

Optionally, the inclusion of an oxidant may be used to ensure that all of the iron is present in its higher ferric oxidation state. Further, oxidation will also ensure that any phosphorus is also present in its higher phosphate oxidation state, such that the formation of ferric phosphate is promoted. Ferric phosphate, FePO₄, has a very low aqueous solubility, such that the iron and the phosphorus will mutually remove each other. Any suitable oxidant may be used, such as, but not limited to, hydrogen peroxide, chlorine or ozone. The latter two are preferred since they avoid the addition of water.

The leach slurry 14 produced in leaching step 12 then proceeds to solid-liquid separation 15, which may be effected by any convenient means, such as, but not limited to, flocculation and thickening, countercurrent decantation, filter press or vacuum belt filter. The solids 16 from the leach slurry 14 will be predominantly silica, and as such are environmentally benign and may be, for example, disposed of as landfill or used as road aggregate. Alternatively, they are sufficiently pure that they may be used as a precursor for high-purity silica production.

The filtrate 17 is predominantly a solution of aluminium chloride with minor impurities 19, such as, but not limited to, iron, chromium, silica, titanium and zinc. The amounts of these impurities 19 will be dependent upon the composition of the feed material 10, but will typically less than 5 g/L, and usually less than about 1 g/L.

Purification of these types of AlCl₃ liquors 17 or solutions is classically carried out by multiple stages of salting-out crystallisation effected by dry HCl gas. In contrast, the primary purification in the process of the present disclosure is carried out by a series of ion exchange resins 18. The nature of the impurities 19 will determine how many stages of ion exchange (IX) 18 are required, but will typically be two or three. Solvent extraction (SX) may be equally employed, but IX 18 is preferred.

The AlCl₃ liquor 17 first undergoes removal of those elements which form chloro-anions in strong chloride solutions, such as, but not limited to, iron, chromium and zinc. Resins with quaternary or tertiary amine functionality are preferred. If titanium is present, it tends to form an oxy-cation rather than a chloro anion, and can be secondarily effectively removed by a cationic resin. Resins with a phosphinic acid functionality are preferred. Finally, if silica is present, it may be removed in a third stage of ion exchange 18 by a resin adsorber with, for example, an amorphous iron oxide structure. Optionally, the silica removal stage may be effected first in case residual iron is dissolved from the silica adsorbent. In this way, all of iron, zinc, chromium, titanium and silica 19 can be removed from the AlCl₃ liquor 17 to produce a semi-purified AlCl₃ liquor 20. The loaded resins can be effectively stripped with either water (anionic) or hydrochloric acid.

The semi-purified AlCl₃ liquor 20 can then optionally undergo a novel magnesium and calcium removal step 21 should it be necessary to remove high levels (≥500 mg/L) of such elements. In this step, the semi-purified AlCl₃ liquor 20 is mixed with solid aluminium fluoride 22, which is only very slightly soluble, at any suitable temperature from ambient to boiling. Ambient is preferred. It has been found that it reacts with magnesium and calcium in a metathetic reaction to form their respective fluorides, both of which are essentially insoluble. The amount of aluminium fluoride added is dependent upon the concentrations of magnesium and calcium in the semi-purified AlCl₃ liquor 20. A slight excess over stoichiometric, about 5%, is added. A small amount of soluble fluoride in the solution is not a problem proceeding to the next step, since it will be recovered and recycled with the hydrochloric acid. The reactions are shown in equations (2) and (3).

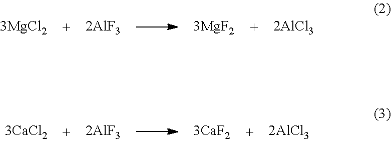

The slurry 23 from magnesium and calcium removal proceeds to solid-liquid separation 24, which may be effected by any convenient means, such as, but not limited to, flocculation and thickening, countercurrent decantation, filter press or vacuum belt filter. The solids 25 are a mixture of magnesium and calcium fluorides.

The filtrate 26 then undergoes pyrohydrolysis 27. This is a common and well-known process in the steel pickling and magnesia industries, but has not been applied to aluminium chloride solutions commercially. Aluminium chloride is converted to a reactive form of alumina 28, and the hydrochloric acid 13 is recovered for recycle. The nature of the pyrohydrolysis process 27 is such that sub-azeotropic acid 13, of strength about 18%, is also recovered.

Pyrohydrolysis of the AlCl₃ liquor is carried out in a spray or fluid bed roaster at a temperature below 900° C., such as below 800° C. In certain embodiments, the pyrohydrolysis is carried out at 600-700° C. Pyrohydrolysis can be carried out with the gas phase containing a partial pressure of carbon dioxide, CO₂, which should be approximately 15% by volume, but no greater than 20%. The purpose of the carbon dioxide is to react with the calcium and magnesium present in the feed solution, converting them to their bicarbonates, according to the following reactions:

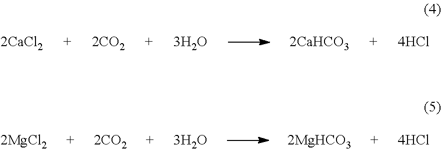

It is an advantageous aspect of the process that these bicarbonates are formed, since they are highly soluble in water, and thus calcium and magnesium are easily removed in the subsequent washing step. Aluminium, on the other hand, does not form carbonates, and hence converts into its oxide.

The alumina solids 28 then undergo a washing step 29 with water 30. Firstly, the washing step 29 removes non-hydrolysable metal chlorides. Notably, this step removes both the metal (Na, K, Ca) and residual chloride. Secondly, the washing step 29 removes the bicarbonates and residual oxides of Mg and Ca 33 formed during the pyrohydrolysis step. Especially if HPA-quality product is required, then the washing step 29 should be carried out with deionised water 30. The washing step 29 may also remove residual low levels of any magnesium or calcium oxides 33, since they have a low level of solubility in water.

The wash slurry 31 proceeds to solid-liquid separation 32, which may be effected by any convenient means, such as, but not limited to, flocculation and thickening, countercurrent decantation, filter press or vacuum belt filter. The solution 33 contains the aforementioned alkali metals with traces of magnesium and calcium, and is either disposed of or, preferably, used as quench liquor for condensing the HCl emanating from the pyrohydrolysis process.

The obtained solids 34 are dried and calcined 35 to form a final alumina product 36. Under normal circumstances, especially if the feed material 10 is kaolinite and/or halloysite, then the product should be at least 4N HPA quality. However, optionally, should an even purer product be required, especially if silica and magnesium have not been completely effectively removed, then the wet, washed solids 34 may be dissolved in caustic soda (not shown) to form a sodium aluminate solution. In this instance, magnesium and calcium will not dissolve, and silica can be subsequently removed with lime, as is done in the Bayer process. The sodium aluminate solution can then be treated as in the existing Bayer process to hydrolyse the aluminium and precipitate Gibbsite (Al(OH)₃), which may subsequently calcined to alumina. The product from this will be suitable for existing aluminium smelters, but will also be 4N or 5N HPA quality.

The principles of the present invention are illustrated by the following examples, which are provided by way of illustration, but should not be taken as limiting the scope of the invention:

### Example 1

A sample of kaolinite and halloysite mineral mixture from South Australia was calcined at various temperatures in order to determine the optimum temperature for leaching. The calcined material was then leached in HCl at acid strengths of 32% and 18% to represent whether the recovered acid came from calcining of ACH crystals or from pyrohydrolysing. In general, except where indicated otherwise, leaching was carried out under standard conditions of 10% solids loading, 32% acid, 95° C. and 2 hours residence time. Table 1 shows the results of these tests.

TABLE 1
Results of Calcining and Leaching of
Kaolinte and Halloysite Mixture

| Calcine | Time, | Leaching | | Temp., | Aluminium |
|---|---|---|---|---|---|
| Temp., ° C. | min | HCl, % | Solids, % | ° C. | Extraction, % |
| 800 | 45 | 32 | 10 | 95 | 96.4 |
| 850 | 15 | 32 | 10 | 95 | 97.8 |
| 850 | 45 | 32 | 10 | 95 | 98.4 |
| 850 | 75 | 32 | 10 | 95 | 98.1 |
| 900 | 45 | 32 | 10 | 95 | 97.3 |
| 850 | 45 | 32 | 25 | 95 | 76.3 |
| 850 | 45 | 32 | 20 | 95 | 95.4 |
| 850 | 45 | 18 | 15 | 95 | 98.2 |
| 850 | 45 | 18 | 10 | 95 | 98.1 |
| 850 | 45 | 18 | 15 | 25 | 0 |

The results indicate that high extractions of aluminium were achieved under all of the calcining conditions tested except for ambient temperature, and that temperature in the range 800° C. to 900° C. had relatively little impact. Mass loss was 16% to 17% during all calcine tests. There was also little impact within the time frame of 15 to 75 minutes. Standard conditions of 45 minutes at 850° C. were adopted for all future leaching tests.

The calcined material had a head grade of 22% aluminium, with iron being the major impurity at 1.08%. The leach tests, as noted above, showed high aluminium extractions under most conditions, with iron extraction being about 60%. In terms of solids loading in the leach, 20% at 32% HCl appears to be the practical maximum consistent with aluminium recovery. Higher percentage solids resulted in lower aluminium recovery. Leaching at ambient temperature showed no reaction taking place with respect to aluminium.

Leaching at a lower acid content of 18%, equivalent to what might be recycled from a pyrohydrolyser, showed equally high aluminium recoveries to using 32% acid at both 10% and 15% solids loading. This example demonstrates that the combination of calcining and leaching with hydrochloric acid is effective in recovering virtually all of the aluminium present in the kaolinite and halloysite mixture.

### Example 2

A composite leach solution, analysing 34.7 g/L Al, 1.09 g/L Fe, 67 mg/L Cr, 19 mg/L Ti, 7.8 mg/L Zn and 120 g/L free HCl from the above tests was treated with various ion exchange resins in shake-out tests at a ratio of 10% resin solids.

TABLE 2
Ion Exchange Impurity Removal

| | Metal Concentration, mg/L | | | | |
|---|---|---|---|---|---|
| Resin | Al | Fe | Cr | Ti | Zn |

Anionic

| | | | | | |
|---|---|---|---|---|---|
| Purolite PFA600 | 34,040 | 29 | 64 | 18 | <0.2 |
| Ambersep 400 | 34,730 | 42 | 64 | 18 | <0.2 |
| Lewatit K6362 | 33,790 | 34 | 64 | 18 | <0.2 |
| Ambersep 920U | 33,170 | 62 | 62 | 18 | <0.2 |
| Lewatit TP107 | 33,760 | 301 | 57 | 17 | <0.2 |

Cationic

| | | | | | |
|---|---|---|---|---|---|
| Lewatit TP 272 | 34,840 | — | — | <1 | — |
| Lewatit TP260 | 32,890 | — | — | <1 | — |

The results show clearly that ion exchange can effectively remove the troublesome impurities from the aluminium chloride solution, and that aluminium itself is essentially not loaded. Whilst not as effective at loading iron, Lewatit TP107 showed some indication of removing chromium. Reducing the free acid content, which was 50-100 g/L HCl, will permit chromium removal. The fact that the anionic resins did not remove titanium whereas the cationic did indicates that titanium is present as an oxy-cation in these solutions rather than as an anionic species.

### Example 3

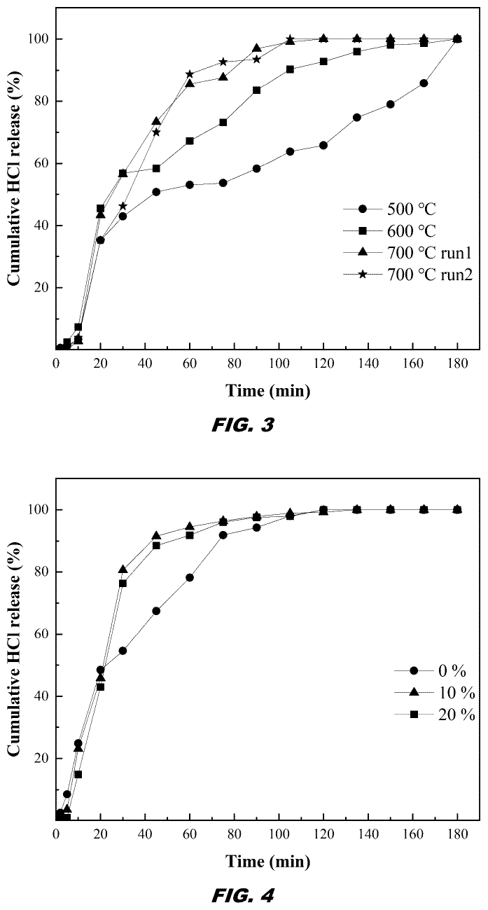

A synthetic chloride leach solution, based on the optimum results of the of the leaching test was prepared with the following analysis in mg/L: Al 44,200, Ca 85, Cr 4, K 420, Mg 90 and Na 72. This solution was then fed to a laboratory pyrohydrolysis unit to investigate the effect of isothermal operating temperature. Pyrohydrolysis was carried out isothermally at 500° C.-700° C. with a total gas flow rate of 200 ml/min and 15v % steam. FIG. 3 shows the results obtained.

These data show that 600° C. is more effective than 500° C., and that substantially all of the HCl is recovered.

### Example 4

Solids generated from the previous test at 600° C. pyrohydrolysis conditions were slurried with deionised water for 3 hours at both 20° C. and 90° C. at a S/L ratio of 1:100. Table 3 shows the analyses of the solids and Table 4 the analyses of the wash solutions.

TABLE 3
Solids Analysis after Washing at 20° C. and 90° C.

| | Al₂O₃, | CaO, | MgO, | Na₂O, | K₂O, | Cl, |
|---|---|---|---|---|---|---|
| | % | % | % | % | % | % |
| Feed Solids | 95.73 | 0.42 | 0.29 | 0.34 | 1.08 | 2.14 |

Washing at 20° C.

| | | | | | | |
|---|---|---|---|---|---|---|
| Stage 1 | 97.31 | 0.39 | 0.24 | 0.30 | 0.68 | 1.06 |
| Stage 2 | 97.55 | 0.37 | 0.23 | 0.24 | 0.65 | 0.95 |
| Stage 3 | 97.65 | 0.35 | 0.22 | 0.22 | 0.64 | 0.90 |
| Stage 4 | 97.77 | 0.34 | 0.21 | 0.19 | 0.64 | 0.84 |
| Removal, % | 0.68 | 27.0 | 32.2 | 43.6 | 59.4 | 85.9 |

Washing at 90° C.

| | | | | | | |
|---|---|---|---|---|---|---|
| Stage 1 | 98.61 | 0.17 | 0.10 | 0.14 | 0.39 | 0.58 |
| Stage 2 | 99.55 | 0.06 | 0.04 | 0.01 | 0.10 | 0.22 |
| Stage 3 | 99.80 | 0.03 | 0.02 | — | 0.02 | 0.14 |
| Stage 4 | 99.98 | — | — | — | 0.01 | 0.01 |
| Removal, % | 3.48 | 99.0 | 99.6 | 102.2 | 99.2 | 99.3 |

TABLE 4
Solids Analysis after Washing at 20° C. and 90° C.

| | | | | | |
|---|---|---|---|---|---|
| Al, | Ca, | Mg, | Na, | K, | Cl, |
| mg/L | mg/L | mg/L | mg/L | mg/L | mg/L |

Washing at 20° C.

| | | | | | | |
|---|---|---|---|---|---|---|
| Stage 1 | 25.7 | 2.50 | 2.98 | 3.00 | 35.0 | 110 |
| Stage 2 | 4.62 | 2.64 | 1.34 | 21.5 | 15.5 | 60.6 |
| Stage 3 | 3.68 | 1.87 | 0.81 | 4.42 | 2.03 | 12.4 |
| Stage 4 | 0.56 | 1.08 | 0.37 | 1.82 | 0.89 | 5.30 |

Washing at 90° C.

| | | | | | | |
|---|---|---|---|---|---|---|
| Stage 1 | 112 | 18.6 | 11.3 | 15.6 | 61.3 | 162 |
| Stage 2 | 34.8 | 10.6 | 4.56 | 12.8 | 31.4 | 47.9 |
| Stage 3 | 30.1 | 3.68 | 2.46 | 2.36 | 9.34 | 12.0 |
| Stage 4 | 31.5 | 2.37 | 1.53 | 0.99 | 1.15 | 16.5 |

The results show that washing at 90° C. is highly efficient and that virtually all of the impurities were removed. An extra stage of washing would effectively remove the final traces of chlorine, and if not, calcining of the washed solids will.

### Example 5

The same solution used in Example 3 was subjected to isothermal pyrohydrolysis at 600° C., with varying partial pressures of carbon dioxide present in the gas phase. The total gas flow rate was 400 ml/min with 15v % steam. FIG. 4 shows the results obtained.

The data show that pyrohydrolysis was more effective with CO₂ present in the gas phase, with an ideal content between 10% and 20%.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

1. A process for producing alumina from an aluminous material feedstock, the process comprising:
i. producing an AlCl₃ liquor,
ii. reducing the content of impurities in the AlCl₃ liquor by ion exchange or solvent extraction to produce a semi-purified AlCl₃ liquor,
iii. pyrohydrolysing the semi-purified AlCl₃ liquor to produce crude alumina solids,
iv. washing the crude alumina solids to remove non-hydrolysable chlorides and/or residual alkaline earth oxides and bicarbonates and produce washed solids, and
v. drying and calcining the washed solids to produce alumina.

2. The process according to claim 1 further comprising redissolution of the alumina obtained from step iv. in caustic soda solution followed by hydrolysis to form gibbsite.

3. The process according to either claim 1 further comprising removing magnesium and calcium from the semi-purified AlCl₃ liquor produced in step ii.

4. The process according to claim 3 comprising removing magnesium and calcium from the semi-purified AlCl₃ liquor by adding a fluoride ion to effect a precipitation of magnesium and calcium.

5. The process according to claim 4 wherein a source of the fluoride ion is aluminium fluoride.

6. The process according to claim 1 wherein the aluminous material feedstock is a kaolinitic material.

7. The process according to claim 6 wherein the kaolinitic material is kaolinite or halloysite or a mixture thereof.

8. The process according to claim 1 wherein step i. comprises:
ia. calcining the feedstock to produce a calcine product,
ib. leaching the calcine in hydrochloric acid to produce a leach slurry, and
ic. removing silicate residue from the leach slurry by solid-liquid separation to produce the AlCl₃ liquor.

9. The process according to claim 8 wherein a calcination temperature used in step ia. is from about 600° C. to about 1000° C.

10. The process according to claim 9 wherein the leaching temperature used in step ib. is from ambient to boiling.

11. The process according to claim 10 wherein an acid strength of the hydrochloric acid used in step ib. is from 5% to 35% HCl.

12. The process according to claim 8 wherein the hydrochloric acid used in step ib. is recycled from the pyrohydrolysing step iii.

13. The process according to claim 1 wherein step ii. comprises a first stage comprising a step of reducing an amount of anionic impurities, such as, but not limited, to iron, zinc and chromium, by contacting the AlCl₃ liquor with a quaternary or tertiary amine extractant.

14. The process according to claim 13 wherein step ii. further comprises a second stage comprising a step of reducing an amount of complex cationic impurities, such as, but not limited to, titanium, by contacting the AlCl₃ liquor with a cationic exchanger.

15. The process according to claim 14 wherein the cationic exchanger is a phosphinic acid or an iminodiacetic acid.

16. The process according to claim 13 wherein step ii. further comprises a third stage comprising a step of reducing an amount of silica by contacting the AlCl₃ liquor with an inorganic adsorbent.

17. The process according to claim 16 wherein the inorganic adsorbent is calcined hydrated ferric oxide.

18. The process according to claim 1 wherein step iv. comprises washing the crude alumina solids using de-ionised or distilled water.

19. The process according to claim 18 wherein the washing step removes non-hydrolysable metal chlorides and bicarbonates and residual oxides of Mg and Ca formed during the pyrohydrolysis step.

20. Alumina produced by the process of claim 1.
